(19) United States
(12) Patent Application Publication
(10) Pub. No.: US 2019/0045005 A1
(43) Pub. Date: Feb. 7, 2019

(54) Method for replicating data in a network and a network component

(71) Applicant: Intel Corporation, Santa Clara, CA (US)

(72) Inventors: Timothy Verrall, Pleasant Hill, CA (US); Mark Schmisseur, Phoenix, AZ (US); Thomas Willhalm, Sandhausen (DE); Francesc Guim Bernat, Barcelona (ES); Karthik Kumar, Chandler, AZ (US)

(21) Appl. No.: 15/951,211

(22) Filed: Apr. 12, 2018

(51) Int. Cl. H04L 29/08

(52) U.S. Cl. CPC H04L 67/1095; H04W 88/08; H04L 67/18

(57) ABSTRACT

A method for replicating data to one or more distributed network nodes of a network is proposed. A movement of a moving entity having associated data stored on a first node of the network is estimated. The moving entity is physically moving between nodes of the network. According to the method, at least a second node of the network depending on the estimated movement is chosen. The method contains replicating the associated data of the first node to the second node or a group of nodes and contains managing how data is stored at those nodes based on the moving entity.

### FIELD

Examples relate to methods for replicating data to one or more distributed network nodes of a network. Further examples relate to network components, apparatuses for replicating data, network switches, central offices, base stations, and moving entities.

### BACKGROUND

Edge computing services provide computing resources to edge devices. An edge device can be an electronic device like a mobile phone or a car communicating via a wireless connection with transceiver systems, e.g. network nodes of the edge computing service. A computing resource can be a server situated in a network node like a base station of a mobile network. Using edge computing services may enable outsourcing computational tasks from edge devices while serving ultra-low latency requirements from the edge devices.

An edge device like an autonomous car can have sensors and can send sensor data to base stations to request data evaluation or processing, for example. Two data sets may be used at a computing resource at the base station. The first data set may relate to current data received from the edge device, e.g. including the data stream from various sensors in the car that are received at the base station in real-time. The second data set may relate to historical data stored at the base station, e.g. including the previous aggregated data from the edge device itself (e.g. to evaluate a deviation of the sensor data of the specific device) and to other reference data from similar edge devices.

A main requirement for edge computing can be processing and analyzing data from the edge device in real-time. For example, the data can be computed by a base station located nearest to the edge device to enable fast responses to the edge device due to short physical distances between the edge device and the base station. When an edge device like the car or a drone is moving, obviously, the nearest base station may change with time from the perspective of the edge device. Therefore, the edge device may send current data to a different base station while it moves. The aforementioned historical data potentially required for processing and analyzing the current data from the edge device might not be available at the actual base station the edge device is sending data to. Establishing a connection and reading the data from the former base station may take time and may limit performing low latency computing by the edge computing service. There may be a need for improved concepts for edge computing with reduced latency.

### BRIEF DESCRIPTION OF THE FIGURES

Some examples of apparatuses and/or methods will be described in the following by way of example only, and with reference to the accompanying figures, in which

FIG. 1 shows an example of a method for replicating data from a first to a second network node of a network;

FIG. 2 shows an example of a network component with an estimation component and a selection component;

FIG. 3 shows an example of an edge computing system with a moving entity;

FIG. 4 shows an example of an edge computing system configured to replicate data from at least a first base station to a second base station; and

FIG. 5 shows an example of a network system from a high-level perspective.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

Edge computing services can provide a number of connection points or network nodes, e.g. in base stations of a mobile network, an edge device can communicate with. In an example, a moving edge device or moving entity can communicate with a first base station and send data to the first base station during a first period of time, e.g. to use edge computing provided by the base station. The first base station may store the data associated to the moving entity and may evaluate further received data from the moving entity based on the associated stored or historical data. The first base station may send responses comprising e.g. an evaluation result back to the moving entity. In this way, complex computational tasks may be efficiently performed while avoiding the need to provide high computational capacities at the moving entity.

After the first period of time, the moving entity may leave a region of the first base station and approximate to a second base station. For example, the radio connection to the first base station may interrupt or the second base station is closer to the moving entity such that an evaluation result can be received faster from the second base station than from the first base station. The moving entity may accordingly stop sending data to the first base station and start communicating with the second base station. The moving entity may send further data to the second base station and the further data associated to the moving entity may be stored at the second base station. To evaluate the received further data, the second base station may have a need for the historical data stored at the first base station.

Other concepts may lack the ability of providing data from the first base station to a second base station fast enough to ensure continuous low latency edge computing for the moving entity. Capabilities such as recognizing and handling data migration are necessary so that computational services can always be performed at a base station and/or a central office closest to the moving entity without delay effects or exuberant amount of data to copy to a plurality of random base stations. A base station may present a network node comprising at least a processor to perform computational tasks and memory to store data. Network nodes may cover respective node regions and may be distributed for example in a grid structure or a comb structure. Concepts for replicating data to a network node are proposed.

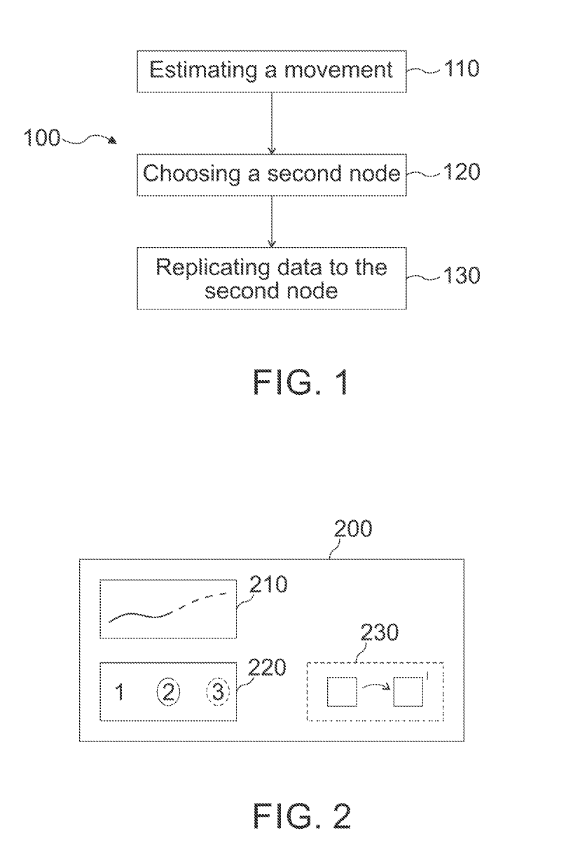

FIG. 1 shows an example of a method 100 for replicating data from a first network node to at least a second network node of a network. The method 100 for replicating data to one or more distributed network nodes comprises estimating 110 a movement, e.g. a trajectory, of a moving entity having associated data stored on a first node of the network. The moving entity is moving between different nodes of the network, e.g. physically moving between spatially distributed network nodes. The method 100 comprises choosing 120 at least a second node of the network depending on the estimated movement and replicating 130 the associated data of the first node to the second node.

The method 100 may be used for replicating 130 data to at least one network node of the network, for example when a moving entity of the network, e.g. a network providing edge computing services, approximates to the at least one network node. A first network node may evaluate data from the moving entity based on data associated to the moving entity stored at the first node. A second network node may be configured to evaluate the data equivalent to the first network node but may lack the stored data associated to the moving entity that may be needed for the evaluation or data processing. To enable continuous data evaluation or data processing, the associated data stored on the first node can be replicated 130 at least to the second node before the moving entity starts communicating with the second node.

By using the method 100, the associated data can be available at the second network node at the time when the moving entity arrives in a region of the second node, stops communicating with the first node, and starts sending data to the second node. By replicating 130 the stored data to the second node, the second node can continue the evaluation tasks and/or computational tasks of the first node while avoiding a delay or causing an interruption when the moving entity changes the network node it is communicating with. For example, the moving entity may exchange data with the first node or the second node via a radio link for communicating. The method 100 may enable that the change of the network node passes unnoticed, e.g. regarding the quality of an edge computing service provided by the network nodes.

Instead of replicating the data to a plurality of network nodes, according to the method 100 it may be possible to replicate 130 the data at exactly the network node the moving entity is approximating to. In other words, the method 100 may provide or use a forecast about which of different network nodes of the network will need the stored associated data from the first node in the future to continue providing e.g. edge computing service to the moving entity.

In order to forecast the node the moving entity will most probably change to after stopping communicating with the first node, the method 100 comprises estimating 110 a movement of the moving entity. That movement may be estimated 110 based on a former movement of the moving entity. For example, an average direction and/or an average speed of the moving entity within for example five seconds (or within 10 seconds, or within 20 seconds, or within one minute) before estimating 110 the movement may be extrapolated to estimate 110 the future movement of the moving entity. Average direction and/or average speed may be determined by at least one of position sensors, inertial sensors, based on a global positioning system, determining former positions of the moving entity based on a radio link, and angular positioning. Providing the average speed may enable to predict a time of a change from the first node to the second node. Depending on the predicted time of change, the associated data may be replicated 130 faster or with a higher priority (for example, if the moving entity is about to start communicating with the second node) or slower (for example, if there is still time before the moving entity will start communicating with the second node).

The moving entity may move on a street, for example a highway, and the estimated movement may be based on the course of the street. It may be very probable that the moving entity follows the course of the street, for example if there are no junctions of the street nearby. There may be a navigation system running on the moving entity, navigating the moving entity. It may be possible to estimate 110 the future movement of the moving entity based on the planned course of the moving entity determined by the navigation system. Especially if the moving entity is e.g. autonomously moving, the probability that the moving entity follows a planned course may be high and the future movement of the moving entity may be reliably estimated 110.

The method 100 comprises choosing 120 at least a second node of a plurality of network nodes. Choosing 120 the second node and/or a further node depends on the estimated movement of the moving entity. According to an example, the estimated movement shows that the moving entity is heading from the first node directly into the direction of the second node. It may be highly probable that after interrupting communicating with the first note, the moving entity will start communicating with the second node and send data to the second node. The determined second node may be chosen 120 and the associated data may be replicated 130 exclusively to the second node. According to another example, the estimated movement shows that the moving entity is heading into a direction between the second and a third node of the network. There may be an uncertainty about whether the moving entity will start sending data to the second or the third node. The second and the third node may be chosen 120 and the associated data may be replicated 130 to both the second and the third node. In an example, the moving entity itself can indicate where it is moving to and with which network node it is planning to start communicating.

Replicating 130 the associated data may comprise copying all associated data of the moving entity stored at the first node to the second node. In some situations however, it might not be necessary to replicate all the associated data available at the first node to the second node, for example a part of the associated data may be outdated data. Replicating 130 data may comprise replicating current data associated to the moving entity. By replicating only current data, an amount of data to be transmitted from the first node to the second node may be reduced. Replicating 130 the data may comprise transmitting the data from the first node to the second node. The data may be transmitted via radio link and/or via cable connection. Transmitting the data directly to the second node may reduce a time duration needed to replicate 130 the data. The first and the second node may be grouped within the network in a group organized by a central office. The central office may be a server station or a server farm of the network. For replicating 130 the data to the second node it can be possible to transmit the data from the first node to the central office and to forward the data from the central office to the second node. Redirecting the data from the central office to the second node may facilitate replicating 130 the data to further nodes of the network and/or to more distant nodes.

According to an example of the method 100, a group of nodes can be chosen and the associated data can be replicated to each node of the group. For example, the estimated movement of the moving entity may show low reliability and choosing a group of notes may increase the probability that the node the moving entity will start communicating with is included in the group of nodes. Choosing a group of nodes may be used if for example an approximate direction of the moving entity is determined. For example, all network nodes in the determined direction from the perspective of the first node may be chosen 120 in the group of nodes. The group of nodes may comprise two, three or more nodes located next to the first node. The number of nodes comprised by the group may depend on a reliability of the estimated movement of the moving entity. For example, there might be no possibility to determine the estimated movement of the moving entity and the associated data may be replicated 130 at all nodes of the network surrounding the first node.

For example, the associated data is transmitted from the first node to the group of nodes using a multicast protocol. By using the multicast protocol, the associated data may be efficiently sent to the group in a single transmission. The data transmission may be addressed to the group of chosen nodes and the data may be replicated at the respective nodes simultaneously. Using the multicast protocol may increase an efficiency for replicating 130 data to more than one network node.

According to an example of the method 100, choosing 120 the at least second node can be based on a probability indicating whether the moving entity will move towards the at least second node. For example, there may be a plurality of network nodes surrounding the first node. For each network node of the plurality of network nodes a value can be determined indicating the probability of the moving entity moving to the respective network node. The network node with the highest probability value may be chosen 120 as the second network node. Consequently, the associated data can be replicated 130 to the second network node. Replicating 130 the associated data to the second network node with the highest probability value may reduce a data volume of the network and reduce costs.

The first network node may be communicating with a plurality of moving entities and receiving data from the plurality of moving entities. For edge computing services, high amount of data may be transmitted from the moving entity to the first network node. Storing the data may require a corresponding amount of memory space. However, there might not always be a necessity for keeping the associated data stored at the first node after replicating the associated data to the second node. To reduce the amount of memory space required as the first node, the method 100 optionally provides deleting the associated data from the first node after replicating 130 the data to the second node.

Optionally, the associated data may be deleted at the first node if the moving entity stops exchanging data with the first node and starts exchanging data with the second node. In other words, the associated data may be deleted at the first node at the moment when the moving entity changes the network node it is communicating with. The second node may continue providing for example edge computing services to the moving entity and there might be no longer a need for keeping the associated data at the first node.

For example, the associated data may be deleted at the first node after a predefined threshold time after the moving entity has stopped exchanging data with the first node. It may be possible that the moving entity returns to the first node within a certain time after starting communicating with the second node. Therefore, it may be useful to keep the associated data stored at the first node for a predefined threshold time. For example, the associated data at the first node may only have to be updated with data sent from the moving entity to the second node but it may be avoided to transmit a complete data set of the associated data from the second node back to the first node. After the predefined threshold time it may be unlikely that the moving entity returns to the first node and the associated data may be deleted. The predefined threshold time may be 30 seconds (or one minute, two minutes or 10 minutes). The predefined threshold time may depend on and/or correspond to a coverage region of the network node. The predefined threshold time may depend on the estimated movement of the moving entity, for example may be determined based on the average speed and/or average direction of the moving entity.

For example, the associated data may be deleted at the first node depending on the estimated movement of the moving entity. The estimated movement may be straight, for example the moving entity may move at constant speed in a constant direction. It may be unlikely that the moving entity returns to the first node and the associated data may be deleted at the first note. In another example, the estimated movement may be irregular, for example with a high degree of change of direction and/or speed. In this example, it may be more likely that the moving entity returns to the first node and the associated data may be needed at the first node in the future. Deleting the associated data may be temporary prevented if the estimated movement is irregular. For example, at irregular estimated movement the associated data may be deleted if the moving entity changes from the second node to a third node of the network. For example, at irregular estimated movement the associated data may be deleted after a second, extended threshold time.

For example, the associated data may be deleted at the first node depending on a type of the moving entity. The moving entity can be for example a car or a drone. A drone may change its moving direction more flexible than a car, for example the car has to follow the course of a street. Therefore, a probability that the moving entity returns to the first node may be higher for a drone then for a car. For example, the associated data at the first node may be deleted after a first time period if the moving entity is a car and after a second time period if the moving entity is a car, wherein the first time period may be longer than the second time period.

For example, the associated data may be replicated to two or more nodes of a group of network nodes. For example, the associated data may be deleted from at least a third node of the group of chosen nodes when the moving entity starts exchanging data with the second node. In other words, the associated data may be replicated to the second and the third node to enable for example providing edge computing services for the moving entity at the second and third node in the case the moving entity changes to one of the second and third node. At the time the moving entity starts communicating with the second node it may be clear that the moving entity will not start communicating with the third node and the associated data might not be needed at the third node. Accordingly, the associated data may be deleted at the third node and a usage of memory capacity may be reduced.

As mentioned, edge computing services may require a high amount of data. Therefore it may take some time to replicate 130 the data from the first node to the second node. Optionally, the associated data may be replicated gradually to the second node. Gradually replicating the associated data may comprise replicating the associated data in single parts distributed over time. For example, first parts of the associated data may be replicated to the second node as soon as the estimated movement of the moving entity indicates that the moving entity is approximating to the second node. Replicating 130 the associated data to the second node may stop or may be stopped if the estimated movement changes before the moving entity starts communicating with the second note, for example if the moving entity changes a course or a direction of movement. A result may be that not all of the associated data has to be unnecessarily replicated. Depending for example on an average speed of the moving entity, a remaining time to the change from the first to the second node may be predicted and the associated data may be transmitted to the second node over the remaining time for replicating the associated data gradually.

For example, replicating the associated data gradually may depend on a physical distance between the moving entity and the first node and on a physical distance between the moving entity and the second node. Less parts of the associated data may be transmitted at a first distance between the moving entity and the second node more parts may be transmitted within a same time unit at a second distance between the moving entity and the second note, the second distance smaller than the first distance. For example, the distance between the moving entity and the first node may be higher than the distance between the moving entity and the second node, for example 150% higher (or 200%, or 300% higher) than the distance between the moving entity and the second node to start transmitting more parts of the associated data per time unit. With a higher distance to the first node, the probability increases that the moving entity will stop communicating with the first node and start communicating with the second node, for example. Therefore, it may be necessary that the associated data is available at the second node and a degree of speed of replicating the data may be increased corresponding to the distance of the moving entity to the first node.

In some situations, it may be useful to make or to have the associated data available at a central office of the network. For example, the central office may comprise resources with higher computing power than the network node. High computing power may be necessary in some situations for providing complex edge computing services to the moving entity. Optionally, the associated data may be replicated to a central office of the network. The associated data may be replicated to the central office alternatively and/or additionally to replicating 130 the associated data to the second node. There may be instances where computation may need to be performed at the central office, e.g. due to real-time requirements or high base station load or uncertainty of a trajectory of motion (e.g. the estimated movement) of the moving entity.

For example, the associated data from the central office may be replicated to the second node and/or to a second central office of the network. It may be easy to replicate the associated data for replicating the data to at least the second and a third (or further) base stations. Using the associated data from the central office for replicating it to the second node may be useful, for example if there is no direct data link between the first node and to second node. Replicating the associated data to the second central office may be useful to enable providing the associated data in other parts of their network. For example, the second node may be assigned to the second central office and the first node may be assigned to the first central office. Accordingly, in an example, the associated data from the second central office may be replicated at least to the second node. Transmitting the associated data from the first node to the second node via the first central office and the second central office may be useful when the moving entity changes between network nodes of different groups of the network. By using the estimated movement the data may be available at the second node even if the transmission time is longer caused by the longer transmission path as replicating the data may be started already long enough before the moving entity changes to the second node.

For example, the method 100 may be used to replicate data from the first node to the second node using network nodes comprised in respective base stations or central offices in a cloud based communication network. The method 100 may be applied in cloud based communication networks for example providing edge computing services, wherein the first, second and further network nodes may be provided in base stations or central offices.

For example, the method may be applied in networks with moving entities physically moving between the nodes, wherein the nodes are distributed spatially. The moving entity communicating with a node may be a car moving on a street or a drone moving in the air between two or more nodes, according to the method. For example, the associated data may relate to sensor data of the moving entity. Autonomously or semi-autonomously driving cars may comprise a large number of sensors generating sensor data that has to be evaluated to enable autonomous driving functions of the car. The evaluation may be performed by an edge computing service provided within a base station next to the car. As the car drives along the street a connection to a first base station might interrupt, for example due to a physical distance to the first base station, wherein a second base station may be within a connection range to the car. To provide continuously autonomous driving functions it may be necessary that the edge computing service is shifted from the first base station to the second base station when the car drives from the first base station to the second base station. Autonomous driving functions may require extremely low latencies from the edge computing service.

FIG. 2 shows an example of a network component 200 with an estimation component 210 and a selection component 220. The estimation component 210 is configured to determine an estimated movement of a moving entity having associated data stored on a first node of the network, the moving entity moving between nodes of the network, wherein the network nodes may be distributed spatially. The estimation component may determine the estimated movement by evaluating e.g. a course of the moving entity and/or at least by receiving information about the estimated movement. The selection component 220 is configured to determine at least a second node of the network depending on the estimated movement. The network component 200 may be used to perform the above described method 100. The network component may comprise a list indicating nodes and their respective positions in the surrounding of the node.

The network component 200 may optionally comprise a data scheduling component 230. The data scheduling component 230 is configured to initiate replicating the associated data of the first node to the second node. In order to initiate replicating the associated data, the data scheduling component 230 may copy the associated data from the first node to the secand note, for example if the network component is provided in a central office having access to the first and second node. In order to initiate replicating the associated data, the data scheduling component 230 may transmit or send the associated data from the first node to the second node, for example if the network component is provided within the first node. In order to initiate replicating the associated data, the data scheduling component 230 may send a replication request signal for example to the first node and/or the central office assigned to the first node to request replicating the data, for example if the network component is provided within the moving entity.

The proposed network component may be configured to perform the method 100 or to perform the method 100 in combination or with the assistance of another device or another network component. More details and aspects are mentioned in connection with the embodiments described above or below. The embodiments shown in FIG. 2 may comprise one or more optional additional features corresponding to one or more aspects mentioned in connection with the proposed concept or one or more embodiments described above or below (e.g. FIGS. 1 and 3-5).

An example relates to an apparatus for replicating data to one or more distributed network nodes of a network. The apparatus comprises means for estimating a movement of a moving entity having associated data stored on a first node of the network, the moving entity moving between nodes of the network, means for choosing at least a second node of the network depending on the estimated movement, and means for replicating the associated data of the first node to the second node. The apparatus is configured to perform the method 100.

For example, the apparatus comprises means to determine a group of nodes and means to initiate replicating the associated data to each node of the determined group. More details and aspects with respect to the apparatus are mentioned in connection with the embodiments described above or below. The apparatus may comprise one or more optional additional features corresponding to one or more aspects mentioned in connection with the proposed concept or one or more embodiments described above or below (e.g. FIGS. 1 and 3-5).

An example relates to a network switch comprising a network component described above or below and/or an apparatus described above or below. An example relates to a central office comprising a network component described above or below and/or an apparatus described above or below. An example relates to a base station comprising a network component described above or below and/or an apparatus described above or below. An example relates to a moving entity comprising a network component described above or below and/or an apparatus described above or below.

Some examples relate to a network system or network. The network system may comprise a mobile communication system, for example, any Radio Access Technology (RAT). Corresponding transceivers (mobile transceivers, user equipment base stations, and/or relay stations) in the network or system may, for example, operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code Division Multiple Access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Public Land Mobile Telephony), MTD (Swedish abbreviation for Mobile telephony system D), Public Automated Land Mo-bile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handyphone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, and/or IEEE 802.11ay), technologies operating above 300 GHz and THz bands, (3GPP/LTE based or IEEE 802.11p and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems.

Examples may also be applied to different Single Carrier or OFDM flavors (CP-OFDM, SC-FDMA, SC-OFDM, filter bank-based multicarrier (FBMC), and/or OFDMA) and in particular 3GPP NR (New Radio) by allocating the OFDM carrier data bit vectors to the corresponding symbol resources.

An access node, base station or base station transceiver can be operable to communicate with one or more active mobile transceivers or terminals or moving entities and a base station transceiver can be located in or adjacent to a coverage area of another base station transceiver, e.g. a macro cell base station transceiver or small cell base station transceiver. Hence, examples may provide a mobile communication system comprising one or more mobile transceivers (e.g. cars, drones, land vehicles, air vehicles and/or water vehicles) and one or more base station transceivers, wherein the base station transceivers may establish macro cells or small cells, as e.g. pico-, metro-, or femto cells. A mobile transceiver may further correspond to a smartphone, a cell phone, user equipment, a laptop, a notebook, a personal computer, a Personal Digital Assistant (PDA), a Universal Serial Bus (USB) -stick, and/or a car. A mobile transceiver may also be referred to as UE or mobile in line with the 3GPP terminology.

An example comprises a network system comprising at least one central office, at least two network nodes and at least one moving entity. The network system may be configured to perform the method 100 described above or below. For example, one of the central office, the network nodes, and the moving entity may be configured to estimate a movement of the moving entity. For example, one of the central office, the network nodes, and the moving entity may be configured to choose at least a second node of the network. For example, one of the central office, the network nodes, and the moving entity may be configured to replicate data to the second node or to initiate replicating data to the second node.

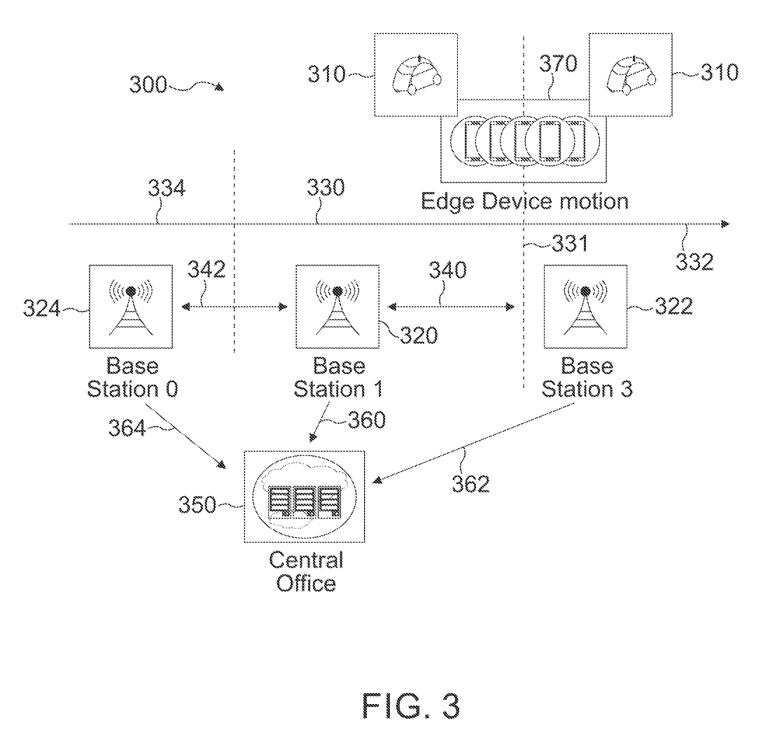

FIG. 3 shows an example of an edge computing system 300 with a moving entity 310. The moving entity may be a car, for example driving along a road (not shown in the FIG. 3). The edge computing system 300 may comprise a first network node 320, a second network node 322 and a further network node 324. The first network node may cover a first region 330, the second network node 322 may cover a second region 332, and the further network node 324 may cover a further region 334. A region of coverage 330, 332, 334 may be the region wherein the moving entity 330 can communicate, for example via a radio link, with the respective base station. A first connection 340 can provide a connection between the first network node and the second network node, and a second connection 342 can provide a connection between the first network node and the further network node. The connection may be a direct radio link between the respective network nodes. The edge computing system 300 may further comprise a central office 350, e.g. a server farm. The network nodes may be configured to establish a respective connection 360, 362, 364 to the central office 350. The network nodes may comprise computation devices configured to provide edge computing services to their moving entity 310. Computation devices may comprise processors, memory, and/or storage.

According to an example, the moving entity 310 may change its location from the first region 330 to the second region 332. After a movement 370 and after crossing a border 331 between the first region 330 and the second region 332, the moving entity 310 may stop communicating with the first network node 320 and start communicating with the second network node 322. During communicating with the first network node 320, the moving entity may have sent data to the first network node and the first network node may have stored the data associated to the moving entity 310. The system 300 may be configured to perform the method 100 and the associated data may be replicated from the first network node to the second network node. For example, the moving entity 310 may have indicated to the first network node 320 that it is moving from the first region 330 into the direction of the second region 332 with the second network node 322. The moving entity of 310 may have initiated replicating the associated data to the second network node 322 before crossing the border 331, for example. Alternatively, the first network node 320 may have determined that the moving entity 310 is heading into the direction of the second network node 322. The first network node 320 may have replicated, for example transmitted, the associated data of the moving entity 310 to the second network node 322 before the moving entity has crossed the border 331. For example, the first network node 320 may have started replicating the associated data at the moment, when the moving entity has started the movement 370 into the direction of the second network node.

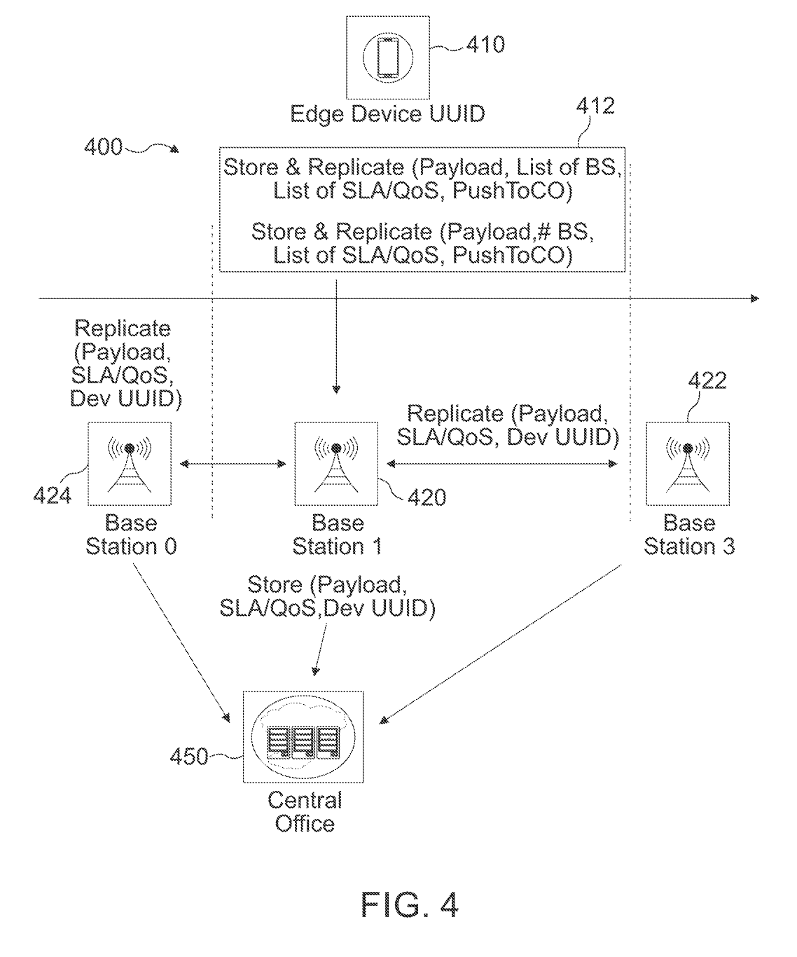

FIG. 4 shows an example of an edge computing system 400 configured to replicate data from at least a first base station 420 to a second base station 422. The edge computing system 400 may be further configured to replicate data to a further base station 424 and/or to replicate data to the first base station 420. In the edge computing system 400, a movement of a moving entity 410 may be estimated. Depending on the estimated movement of the moving entity 410, for example a mobile phone, associated data of the moving entity, stored at one of the base stations can be replicated to at least one of the other base stations. For example, the moving entity 410 may send data to the first base station 420. The estimated movement may indicate that the moving entity 410 is moving to the second base station 422. A list of base stations can be determined within the edge computing system 400, the list comprising chosen base stations the associated data of the first base station is required to be replicated to. To replicate the associated data to the second base station, it may be transmitted to a central office 450 of the edge computing system 400 and be redirected to the second date base station 422 from the central office 450.

It may be possible that the moving entity 410 sends a request information 412 to the first base station 420, indicating a request to replicate data that the moving entity 410 generates to several locations of the system infrastructure at once. The request information 412 may comprise two different type of locations where a given payload, for example sensor data of the moving entity 410 transmitted to the first base station 420, needs to be stored. The request information 412 may comprise a list of base stations. In this case e.g., the data may be assumed to be time-critical and the moving entity needs to make it available as soon as possible whenever a change occurs from the current base station to the next one. The request information 412 may further (alternatively or additionally) comprise a list of central offices. In this case e.g., the data may be assumed to be less time-critical and some latency may be tolerated. Thereby, the next base station can fetch or load the data from the central office if the data has been already placed there. A main aspect of this use case may be to enable increased spatial distribution of the data.

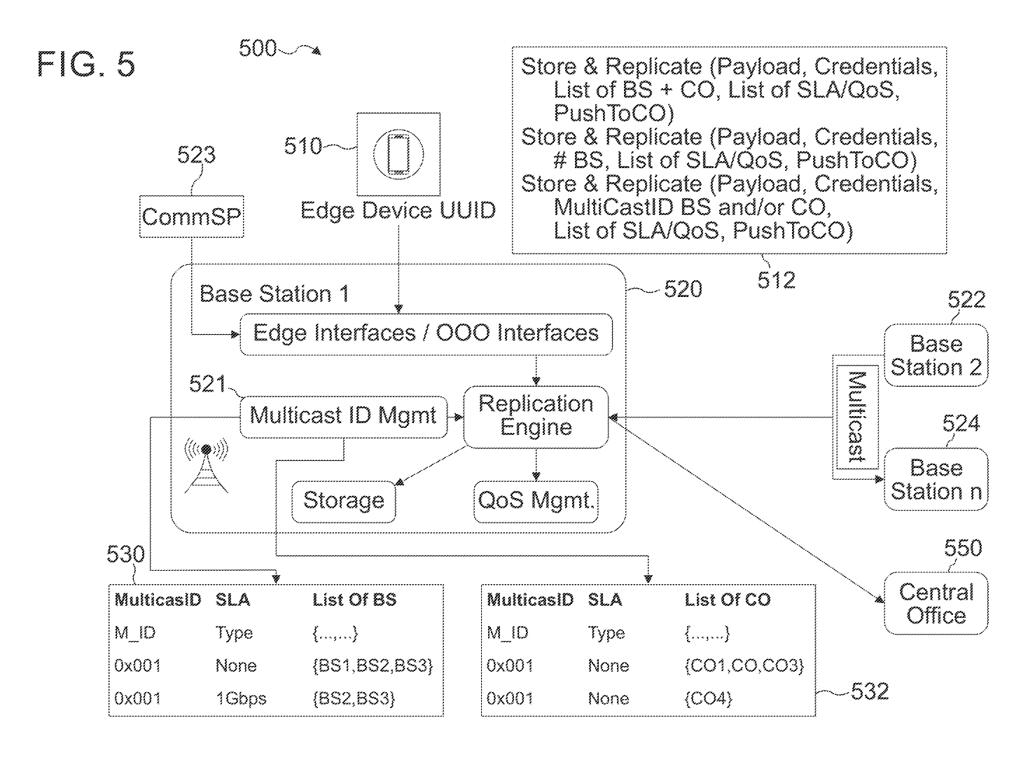

FIG. 5 shows an example of a network system 500 from a high-level perspective. The network system 500 comprises a first base station 520, a second base station 522, and at least a further base station 524. The base stations may be connected to a central office 550 of the network system 500. The network system 500 may further comprise a moving entity 510 configured to communicate with the base stations. For example, the moving entity 510 may be communicating with the first base station 520. An information message 512 may comprise information about the payload (e.g. data) to be replicated, about credentials associated to the payload, a list of potential service level agreement (SLA) or quality of service (QoS) hints and/or a field that allows specifying that the payload needs to be pushed to the central office (CO).

Compared to other base stations, the base stations 520, 522, 524 may be extended with the following elements. Each base station may expose three additional interfaces that can be used by the device to specify that a given payload needs to be replicated among a set of different storage locations (e.g. other base stations). The three interfaces may have in common the following fields:

Payload to be replicated; credentials associated to the payload (to be used by the base station to authenticate it and to store it to the proper tenant storage partition); a list of potential SLA or QoS hints that allows to specify how relevant is a given replication target (e.g.: replicating the payload to base station 522 is 2× more important than to base station 524—where X is 10 Gpbs); and a field that allows to specify that the payload needs to be pushed to the CO (connected to the base station (BS)) as well. This may be applicable in the case of hierarchical storage.

The differences between the three interfaces e.g. are:

One interface that allows providing a list of BS and/or CO where the data needs to be replicated; one interface that allows providing a number of BS and/or CO—In this case the base station will decide to what BS and CO the data will be replicated. It can use historical information (such as previous hops of the device) to decide to where the data needs to be stored; and one interface that allows providing a MulticastID BS or CO that is known by the base station and that is actually mapped to a set of BS and CO (having BS and CO different multicasts identifiers (IDs)).

When central offices are part of the multicast or replication targets, the base station may propagate the request not only to the peer base stations but as well to the central office where it is connected. The central office may be responsible to replicate that data to its peer central offices at the same time.

It may expose one interface 523 exposed in an out of band fashion which is used by the telecommunication service provider to configure the multicast ID table for base station and central office.

It may include a set of logical elements that are used manage the aforementioned multicast IDS: a Multicast ID mgmt. 521 (management) logic may be responsible to process requests to configure or to discover base stations or central offices associated to a multicast BS or CO ID; a multicast ID BS Table 530 may contain a mapping of multicast ID to: List of base stations associated to that multicast ID; potential list of SLA or QoS fields associated to each of the BS that are part of the multicast list. As example, already mentioned before, one target may have higher priority than others; a multicast ID CO Table 532 may contain a mapping of multicast ID to:

List of central offices associated to that multicast ID; similarly to the BS case, a potential list of SLA or QoS fields associated to each CO.

It may include the replication and QoS; and engines which may be responsible to actually articulate and process the replication requests that are provided sent by the device (e.g. moving entity) itself.

The central offices may be extended as well in order to be able to process the multicast requests coming from the base station. The architecture of the central office could be similar to the one described here for the base station but without including any logic for base station replication.

According to the presented concepts costs and latency time of edge computing may be reduced. The amount of compute resources e.g. tends to highly constraint the closer the device is the edge for a particular workload (e.g.: video processing for a drone). For instance, in a real time service, processing data for an internet of things device (e.g. the moving entity) should be processed in a small cell or base station due to latency requirements (instead of the central office where the latency is higher). In this case, compute resources will tend to be low power and critical to devote to effective edge services.

Other network systems providing data at different network nodes may show increased latency times and/or reduced computational power. In other network systems software solutions could be applied to replicate data that is being stored in one particular edge (e.g.: a small cell, and/or a base Station) to a next potential edges (e.g. a next small cell), potentially increasing latency and overhead when replicating payloads. Other network systems may show increased costs or decreased reliability. Other concepts may require multiple replication and payloads may be replicated a number of different times increasing the amount of traffic in operator infrastructure and backhaul which may have impact on the cost of the network. Other concepts relating to data replication may lack considering movements in a network structure.

An example of the disclosure relates to automatic edge replication schemes for edge storage gateways. Data may be replicated to a single network node where the data is needed instead to a plurality of random network nodes. Replication costs may be reduced. Automatic edge replication may be implemented in hardware or separated devices potentially preventing an impact on computational performance or a workload of the network system.

A main aspect is a mechanism and infrastructure for automated data migration between base stations and their central office, based on the location of the edge device, and the real-time bandwidth and compute load in the infrastructure. This may enable real-time processing for applications such as failure analysis that requires both current and historical data to be done as fast as possible.

An architectural proposal covers different types of automatic replication: in a first example, replication at base station or small cell level (when data is processed to edges more close to the device and it is e.g. known with high probability that next hops will be within the next central office range); in a second example, replication at central office level (when there is a high possibility that the next edge where the device will be connected is a different central office domain); and in a third example, a hybrid scheme comprising the first and second example.

The proposed concepts and schemes may result in: lower total cost of ownership (TCO); in lower latency migration via accelerated schemes; and in coordinated protocol migration between edge devices and the edge (small-cell, macro-cell, base station or central office).

Further aspects are provided by the following examples.

Example 1 comprises a method for replicating data to one or more distributed network nodes of a network, the method comprising: estimating a movement of a moving entity having associated data stored on a first node of the network, the moving entity moving between nodes of the network; choosing at least a second node of the network depending on the estimated movement; and replicating the associated data of the first node to the second node.

Example 2 comprises the method according to example 1, wherein a group of nodes is chosen and the associated data is replicated to each node of the group.

Example 3 comprises the method according to example 2, wherein the associated data is transmitted from the first node to the group of nodes using a multicast protocol.

Example 4 comprises the method according to any of example 1 to 3, wherein choosing the at least second node is based on a probability indicating whether the moving entity will move towards the at least second node.

Example 5 comprises the method according to any of example 1 to 4, wherein the associated data is replicated to the second node, wherein the probability that the moving entity will move to the second node is higher than a probability that the moving entity will move to another node.

Example 6 comprises the method according to any of example 1 to 5, wherein the moving entity is exchanging data with the first node or the second node via a radio link.

Example 7 comprises the method according to any of example 1 to 6, wherein the associated data is deleted at the first node if the moving entity stops exchanging data with the first node and starts exchanging data with the second node.

Example 8 comprises the method according to any of example 1 to 7, wherein the associated data is deleted at the first node after a predefined threshold time after the moving entity has stopped exchanging data with the first node.

Example 9 comprises the method according to any of example 7 to 8, wherein the associated data is deleted at the first node depending on the estimated movement of the moving entity.

Example 10 comprises the method according to any of example 7 to 9, wherein the associated data is deleted at the first node depending on a type of the moving entity.

Example 11 comprises the method according to any of example 7 to 10, wherein the associated data is deleted from at least a third node of a group of chosen nodes when the moving entity starts exchanging data with the second node.

Example 12 comprises the method according to any of example 1 to 11, wherein the associated data is replicated gradually to the second node.

Example 13 comprises the method according to example 12, wherein replicating the associated data gradually depends on a physical distance between the moving entity and the first node and on a physical distance between the moving entity and the second node.

Example 14 comprises the method according to any of example 1 to 13, wherein the associated data is replicated to a central office of the network.

Example 15 comprises the method according to example 14, wherein the associated data from the central office is replicated to the second node.

Example 16 comprises the method according to example 14 or 15, wherein the associated data from the central office is replicated to a second central office of the network.

Example 17 comprises the method according to example 16, wherein the associated data from the second central office is replicated at least to the second node.

Example 18 comprises the method according to any of example 1 to 17, wherein the first node and the second node are comprised in respective base stations or central offices in a cloud based communication network.

Example 19 comprises the method according to example 18, wherein the cloud based communication network is configured to provide edge computing services at the two nodes.

Example 20 comprises the method according to any of example 1 to 19, wherein the moving entity is physically moving between the nodes, wherein the nodes are distributed spatially.

Example 21 comprises the method according to any of example 1 to 20, wherein the moving entity is one of a drone, and a car.

Example 22 comprises the method according to any of example 1 to 21, wherein the associated data relates to sensor data of the moving entity.

Example 23 comprises a network component, comprising an estimation component, configured to determine an estimated movement of a moving entity having associated data stored on a first node of the network, the moving entity moving between nodes of the network; and a selection component, configured to determine at least a second node of the network depending on the estimated movement.

Example 24 comprises the network component according to example 23, further comprising a data scheduling component, configured to initiate replicating the associated data of the first node to the second node.

Example 25 comprises the network component according to example 23 or 24, wherein the selection component is further configured to determine a group of nodes and the data scheduling component is further configured to initiate replicating the associated data to each node of the group.

Example 26 comprises the network component according to example 25, wherein the data scheduling component is configured to initiate transmitting the associated data from the first node to the group of nodes using a multicast protocol.

Example 27 comprises the network component according to example 26, wherein the selection component is configured to choose the at least second node based on a probability about whether the moving entity will move towards the at least second node.

Example 28 comprises the network component according to example 27, wherein the data scheduling component is configured to initiate replicating the associated data to the second node, wherein the probability that the moving entity will move to the second node is higher than a probability that the moving entity will move to another node.

Example 29 comprises the network component according to any of examples 23 to 28, wherein the network component is further configured to initiate deleting the associated data at the first node if the moving entity stops exchanging data with the first node and starts exchanging data with the second node.

Example 30 comprises the network component according to example 29, wherein the network component is configured to initiate deleting the associated data at the first node after a predefined threshold time after the moving entity has stopped exchanging data with the first node.

Example 31 comprises the network component according to example 29 or 30, wherein the network component is configured to initiate deleting the associated data at the first node depending on the estimated movement of the moving entity.

Example 32 comprises the network component according to any of examples 29 to 31, wherein the network component is configured to initiate deleting the associated data at the first node depending on a type of the moving entity.

Example 33 comprises the network component according to any of examples 29 to 32, wherein the network component is configured to initiate deleting the associated data from at least a third node of a group of chosen nodes when the moving entity starts exchanging data with the second node.

Example 34 comprises the network component according to any of examples 29 to 33, wherein the data scheduling component is configured to initiate replicating the associated data gradually to the second node.

Example 35 comprises the network component according to example 34, wherein replicating the associated data gradually by the data scheduling component depends on a physical distance between the moving entity and the first node and on a physical distance between the moving entity and the second node.

Example 36 comprises the network component according to any of examples 23 to 35, wherein the data scheduling component is configured to initiate replicating the associated data to a central office of the network.

Example 37 comprises the network component according to example 36, wherein network component is configured to initiate replicating the associated data from the central office to the second node.

Example 38 comprises the network component according to any of examples 23 to 37, wherein the network component is located at a base station or a central office in a cloud based communication network.

Example 39 comprises the network component according to example 38, wherein the network component is configured to at least receive data from the moving entity via a radio link.

Example 40 comprises the network component according to any of examples 23 to 39, wherein the network component is located at the moving entity.

Example 41 comprises an apparatus for replicating data to one or more distributed network nodes of a network, comprising means for estimating a movement of a moving entity having associated data stored on a first node of the network, the moving entity moving between nodes of the network; means for choosing at least a second node of the network depending on the estimated movement; and means for replicating the associated data of the first node to the second node.

Example 42 comprises the apparatus according to example 41, comprising means to determine a group of nodes and means to initiate replicating the associated data to each node of the determined group.

Example 43 comprises a network switch comprising the network component according to any of examples 23 to 40 or the apparatus according to example 41 or 42.

Example 44 comprises a central office or internet server system comprising the network component according to any of examples 23 to 40 or the apparatus according to example 41 or 42.

Example 45 comprises a base station comprising the network component according to any of examples 23 to 40 or the apparatus according to example 41 or 42.

Example 46 comprises a moving entity comprising the network component according to any of examples 23 to 40 or the apparatus according to example 41 or 42.

The aspects and features mentioned and described together with one or more of the previously detailed examples and figures, may as well be combined with one or more of the other examples in order to replace a like feature of the other example or in order to additionally introduce the feature to the other example.

Example 47 comprises a network system comprising at least one network component according to any of examples 23 to 40 and/or at least one apparatus according to example 41 or 42.

Example 48 comprises a computer program including program code, when executed, to cause a programmable processor to perform the method of any of examples 1 to 22.

Example 49 comprises a non-transitory machine readable storage medium including program code, when executed, to cause a programmable processor to perform the method of any of examples 1 to 22.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, or “means for generating a signal.”, may be implemented in the form of dedicated hardware, such as “a signal provider”, “a signal processing unit”, “a processor”, and/or “a controller”. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A network component, comprising
an estimation component, configured to determine an estimated movement of a moving entity having associated data stored on a first node of the network, the moving entity moving between nodes of the network; and
a selection component, configured to determine at least a second node of the network depending on the estimated movement.

2. The network component according to claim 1, further comprising
a data scheduling component, configured to initiate replicating the associated data of the first node to the second node.

3. The network component according to claim 1,
wherein the selection component is further configured to determine a group of nodes and the data scheduling component is further configured to initiate replicating the associated data to each node of the group.

4. The network component according to claim 3,
wherein the data scheduling component is configured to initiate transmitting the associated data from the first node to the group of nodes using a multicast protocol.

5. The network component according to claim 1,
wherein the selection component is configured to choose the at least second node based on a probability about whether the moving entity will move towards the at least second node.

6. The network component according to claim 5,
wherein the data scheduling component is configured to initiate replicating the associated data to the second node, wherein the probability that the moving entity will move to the second node is higher than a probability that the moving entity will move to another node.

7. The network component according to claim 1,
wherein the network component is further configured to initiate deleting the associated data at the first node if the moving entity stops exchanging data with the first node and starts exchanging data with the second node.

8. The network component according to claim 1,
wherein the network component is configured to initiate deleting the associated data at the first node after a predefined threshold time after the moving entity has stopped exchanging data with the first node.

9. The network component according to claim 1,
wherein the network component is configured to initiate deleting the associated data at the first node depending on the estimated movement of the moving entity.

10. The network component according to claim 1,
wherein the network component is configured to initiate deleting the associated data at the first node depending on a type of the moving entity.

11. The network component according to claim 1,
wherein the network component is configured to initiate deleting the associated data from at least a third node of a group of chosen nodes when the moving entity starts exchanging data with the second node.

12. The network component according to claim 1,
wherein the data scheduling component is configured to initiate replicating the associated data gradually to the second node.

13. The network component according to claim 12,
wherein replicating the associated data gradually by the data scheduling component depends on a physical distance between the moving entity and the first node and on a physical distance between the moving entity and the second node.

14. The network component according to claim 1,
wherein the data scheduling component is configured to initiate replicating the associated data to a central office of the network.

15. The network component according to claim 14,
wherein the network component is configured to initiate replicating the associated data from the central office to the second node.

16. The network component according to claim 1,
wherein the network component is located at a base station or a central office in a cloud based communication network.

17. The network component according to claim 1,
wherein the network component is configured to at least receive data from the moving entity via a radio link.

18. The network component according to claim 1,
wherein the network component is located at the moving entity.

19. A method for replicating data to one or more distributed network nodes of a network, the method comprising:
estimating a movement of a moving entity having associated data stored on a first node of the network, the moving entity moving between nodes of the network;
choosing at least a second node of the network depending on the estimated movement; and
replicating the associated data of the first node to the second node.

20. The method according to claim 19, wherein a group of nodes is chosen and the associated data is replicated to each node of the group.

21. The method according to claim 20, wherein the associated data is transmitted from the first node to the group of nodes using a multicast protocol.

22. The method according to claim 19, wherein the associated data is deleted at the first node if the moving entity stops exchanging data with the first node and starts exchanging data with the second node.

23. The method according to claim 19, wherein the associated data is replicated gradually to the second node depending on a physical distance between the moving entity and the first node and on a physical distance between the moving entity and the second node.

24. An apparatus for replicating data to one or more distributed network nodes of a network, comprising
means for estimating a movement of a moving entity having associated data stored on a first node of the network, the moving entity moving between nodes of the network;
means for choosing at least a second node of the network depending on the estimated movement; and
means for replicating the associated data of the first node to the second node.

25. The apparatus according to claim 24, further comprising means to determine a group of nodes and means to initiate replicating the associated data to each node of the determined group.
